(19) United States
(12) Patent Application Publication
(10) Pub. No.: US 2010/0332738 A1
(43) Pub. Date: Dec. 30, 2010

(54) STORAGE DEVICE AND DATA PROCESSING METHOD

(75) Inventors: Ming-Dar Chen, Chung Ho City (TW); Chuan-Sheng Lin, Chung Ho City (TW); Tzu-Wei Fang, Chung Ho City (TW); Hsiang-An Hsieh, Chung Ho City (TW)

Correspondence Address: Flash Intellectual Property, Inc.;Attn. Cheng-Ju Chiang, P.O. Box 766, Chino, CA, 91708, US

(73) Assignee: A-DATA TECHNOLOGY (SUZHOU) CO., LTD., SuZhou (CN)

(21) Appl. No.: 12/785,405

(22) Filed: May 21, 2010

(30) Foreign Application Priority Data
Jun. 29, 2009 (TW) 098121750

(51) Int. Cl. G06F 12/02; G06F 12/00

(52) U.S. Cl. 711/103; 711/E12.001; 711/E12.008

(57) ABSTRACT

A storage device for connecting to a host system includes a flash memory and a controller coupled to the flash memory. The flash memory includes a plurality of memory blocks. The controller writes test data to the flash memory, and compares the test data read from the flash memory with the original test data to generate a bit error message corresponding to the flash memory. Then, the controller chooses and labels a quick read block from the plurality of memory blocks according to the bit error message, and finally writes a specific file to the quick read block.

### BACKGROUND OF THE INVENTION

1. Field of the Invention

The present invention is generally related to a storage device and corresponding data processing method, and more particularly to a flash memory storage device and corresponding data processing method.

2. Description of the Prior Art

NAND flash memory is widely used in consumer electronic products as a storage media for its high access speed, power saving and high reliability.

With the development of flash memory manufacturing technology, the flash memory develops from Single-Level Cell (SLC) to Multi-Level Cell (MLC). Because the storage density increases, MLC-type flash memory stores more data than SLC-type flash memory. Since each memory cell of MLC-type flash memory stores a plurality of bits, corresponding amount of judge potential should be provided by each memory cell to denote corresponding data. FIG. 1 is voltage state diagram of MLC-type flash memory. Three reference voltages are used in MLC-type flash memory to judge the data denoted by four grades of voltage in the cell. The four states are “U”, “A”, “B”, and “C”. It takes much more time to program or read out MLC-type flash memory because a plurality of operations should be conducted to judge and confirm the voltages of the cell.

Logic operation is needed in MLC-type flash memory for precisely judge the voltage of the cell, which results in differences in reading speed of the memory pages. The access rate of those memory pages which require little logic operations will be fast. While, in fact, the effect of the number of the logic operations on access rate of each memory pages is not noticeably. Although the programming method can appreciably improve the access rate, it is not helpful on access efficiency as a whole.

### SUMMARY OF THE INVENTION

According to the shortcoming of the conventional technology, an objective of the present invention is to provide a storage device and corresponding data processing method to thereby speed up the access rate.

In order to resolve above-mentioned technical issue, the technical solution of the present invention is as follows:

The present invention provides a storage device for connecting to a host system includes a flash memory and a controller coupled to the flash memory. The flash memory includes a plurality of memory blocks. The controller writes test data to the flash memory, and compares the test data read from the flash memory with the original test data to generate a bit error message corresponding to the flash memory. Then, the controller chooses and labels a quick read block from the plurality of memory blocks according to the bit error message, and finally writes a specific file to the quick read block.

The present invention also provides a data processing method used in a storage device which includes a plurality of memory blocks. The data processing method comprises following steps: writing test data to each of the plurality of memory block; reading the test data from the memory block and comparing the test data with the original test data to generate an bit error message corresponding to respective memory block; choosing and labeling a quick read block from the plurality of memory blocks according to the bit error message, and writing specific file to the quick read block.

The present invention has an advantage that the access rate is highly speeded up by selecting and labeling a quick read block to store a specific file, which is required to be quick read, from those memory blocks of the flash memory, in which the bit error is less and the reliability is high.

Other objects, advantages and novel features of the invention will become more apparent from the following detailed description when taken in conjunction with the accompanying drawings.

### BRIEF DESCRIPTION OF THE DRAWINGS

FIG. 1 is a voltage state diagram of MLC-type flash memory;

FIG. 2 is a system chart of a preferred embodiment of a storage device in accordance with the present invention;

FIG. 3 is a flowchart illustrating the initialized storage device of the present invention;

FIG. 4 is a flowchart of a writing action of the present invention;

FIG. 5 is a flowchart of an accessing action of a top access address recorded the present invention; and

FIG. 6 is a flowchart of conveying a specific file of the present invention.

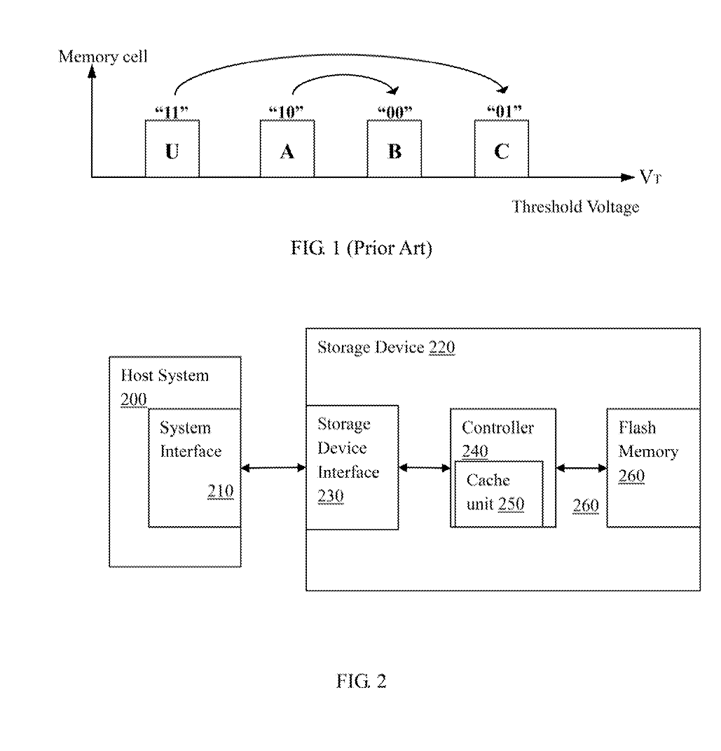

### DETAILED DESCRIPTION OF THE PREFERRED EMBODIMENTS

Reference will now be made in the detail to the preferred embodiments of the invention. While the present invention has been described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

A preferred embodiment of a storage device 220 in accordance with the present invention is shown in FIG. 2. The storage device 220 comprises a storage device interface 230, a controller 240, a cache unit 250 and a flash memory 260. The storage device interface 230 interconnects with a system interface 210 of a host system 200 and exchanges data with the host system 200. The controller 240 is used to execute the control commands of the host system 200. The controller 240 comprises the cache unit 250 which is composed by volatile memory and is used to store a logical address that is reading data. The flash memory 260 connects with the controller 240, which is used to store data.

When the flash memory 260 is initialized, a test data can be written into the flash memory 260 by the controller 240. The controller 240 compares the test data read from the flash memory 260 and the original test data. Bit errors can be found by the comparison. During data comparison, the message, which is relevant to the bit errors in the flash memory 260, can be recorded and counted by the controller 240. The message includes the number of bit errors in each memory block, the average number of bit errors in each memory block (including the number of bit errors/memory pages), and the number of memory pages with no bit errors in each memory block. The user can set a preset value to decide which memory block can be used as a quick access block. The preset value is also can be set by the storage device 220. The blocks, in which the number of bit errors is lower than the preset value, the average number of bit errors is lower than the preset value, or the number of the memory pages with no bit errors is higher than the preset value, can be labeled as quick access blocks. A specific file, that is needed to be accessed quickly, can be accessed from such quick access blocks.

The controller 240 stores labeling information of the quick access blocks into the flash memory 260 after scanning and labeling the storage space of the flash memory 260. The labeling information forms the quick access block list, which is regarded as index of the controller 240 when access the quick access blocks.

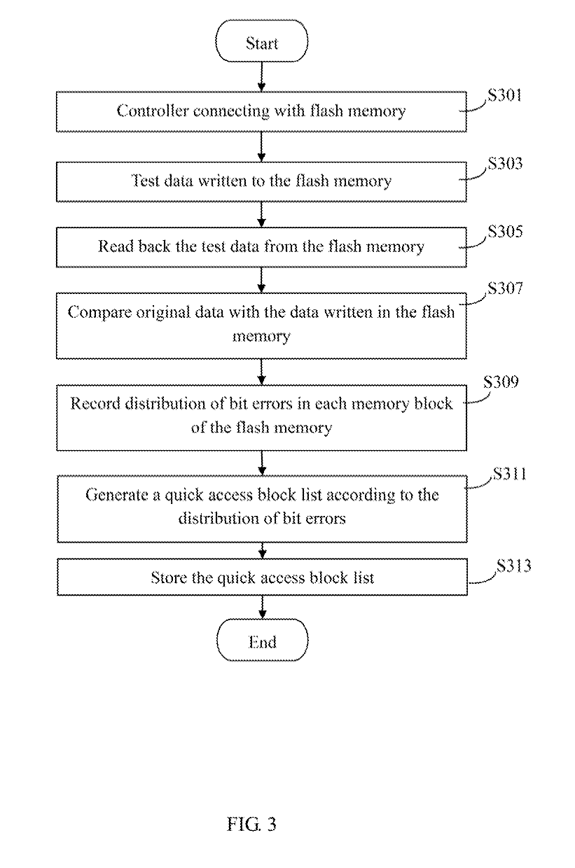

FIG. 3 is a flowchart illustrating the initialized storage device of the present invention. The controller 240 connects to the flash memory 260 (step S301). A test data is written into the flash memory 260 by the controller 240 (step S303). Then, the controller 240 read out the test data from the flash memory 260 (step S305) and compares the test data with the original test data (step S307). Subsequently, a distribution of the bit errors in each memory block of the flash memory 260 is achieved. The controller 240 records the distribution of the bit errors in each memory block of the flash memory 260 (step S309). After that, the controller 240 generates a quick access block list according to the distribution of the bit errors (step S311). Finally, the controller 240 stores the quick access block list into the flash memory 260 as of the index for the controller 240 to access the quick access blocks (step S313).

There are two file allocation approaches provided by the present invention to store a data (i.e. a specific file), which is required a high access rate, to the quick access block.

One file allocation approach is introduced as follows. First, the host system 200 informs the characteristic of the data to the controller 240. The controller 240 stores the data to an appointed storage space according to the characteristic of the data. The host system 200 adds a notice, that the data is the specific file, in the data written command, when there is a need to store a quick access data according to the commands from the user or data format of relevant application program. Then, the controller 240 stores the data to the quick access block.

The other file allocation approach is to track and record the access times of the related access address and then to store the data, which is read out frequently, to the quick access block. In details, when the host system 200 transmits the needs of storing data to the controller 240, the controller 240 will process the data from the host system 200, and in the meanwhile, record a logical address reading the data to the cache unit 250 thereof The access times of each logical address can be counted by recording every logical address. The counting methods can be to record the access times of each logical address or only record the logical address with more access times. According to the statistic data, a top list is formed. When the storage device 220 is switched off or power off, the statistic data in the cache unit 250 can be written into the flash memory 260. The data will be loaded to the cache unit 250 of the controller 240 whenever the storage device 220 is restarted.

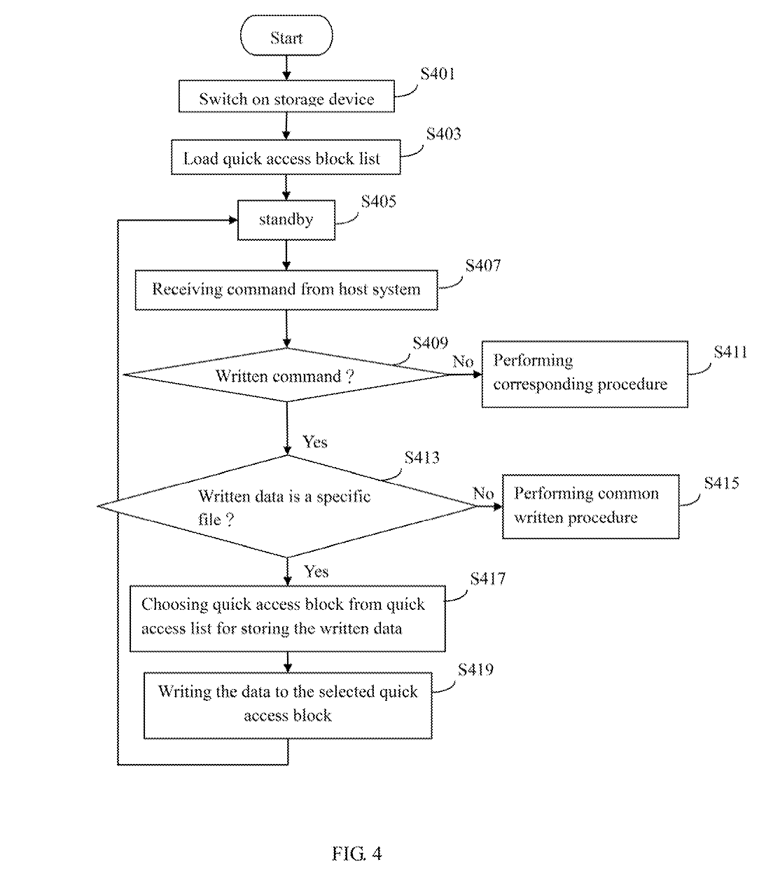

FIG. 4 is a flowchart of a writing action of the present invention. First, the storage device 220 is switched on (step S401). The quick access block list is loaded from the controller 240 (step S403). In other words, the controller 240 reads out the quick access block list from the host system 200 and stores the list temporarily to the cache unit 250. Then, the controller 240 stands by (step S405) and waits for the access commands from the host system 200. When the commands are received (step S407), the controller 240 judges whether it is the written command (step S409). If it is not the written command, corresponding action will be performed (step S411). If it is the written command, the controller 240 will be further judge whether the command, by which a data is denoted, is a specific file (step S413). That is, this specific file is a file needed to be quickly accessed. If there is no relevant denotation, a common written procedure will be performed (step S415). If it is denoted that the data is a specific file, the controller 240 will choose a quick access block from the quick access block list to store the specific file (step S417) therewith. Finally, the data is written to the selected quick access block (step S419). When above-mentioned approach is adopted, the data can be directly read according to a logical/physical table. When receiving and reading the command of accessing data, there is no need to record the top access address for conveying action of the specific file.

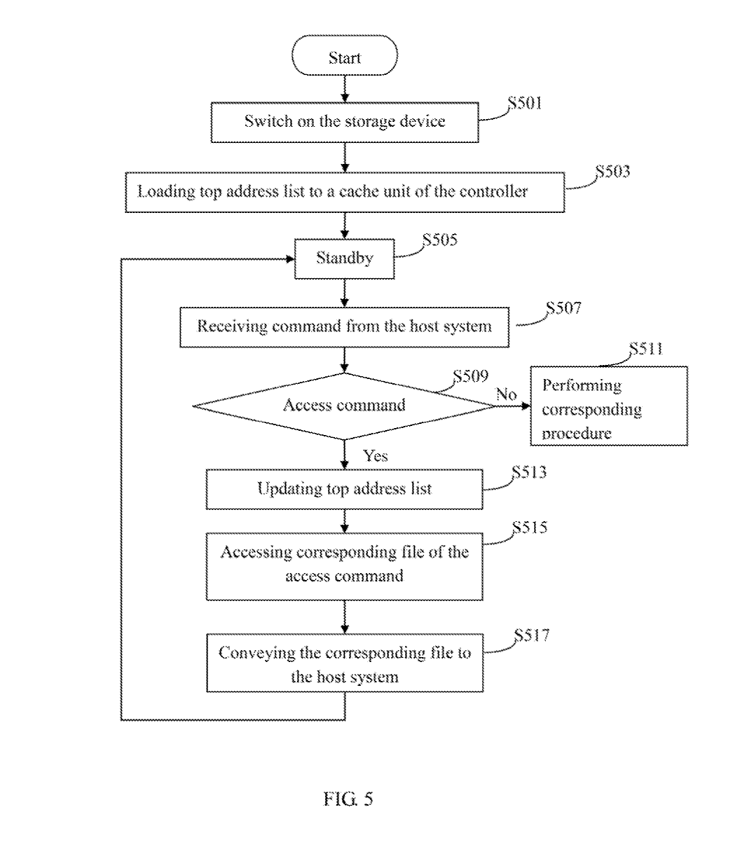

FIG. 5 is a flowchart of a reading action of a top access address recorded by the present invention. First, the storage device 220 is switched on (step S501). The controller 240 loads the top address list (step S503). That is, the top address list is loaded from the flash memory 260 to the cache unit 250 of the controller 240. Then, the storage device 220 stands by (step S505) and waits for receiving a relevant access command from the host system 200. When the host system command is received (step S507), the storage device 220 will judge whether it is an access command (step S509). If it is not the access command, corresponding action of the command will be performed (step S511). If it is the access command, the controller 240 will update the top address list (step S513) and record corresponding logical address of the command on the top address list. If the logical address has been listed in the top address list, then, the number of access times will be increased by one. If the logical address is not listed in the top address list, then, this logical address is added to the top address list. Next, the controller 240 accesses the data, which the command required to read (step S515), and conveys the data to the host system 200 (step S517).

When the storage device 220 is left unused or performs a procedure of reclaiming memory blocks, the data corresponding to the top address list can be stored to the preset quick access block. In such a manner, a better access rate will be achieved when the host system needs to access the data next time.

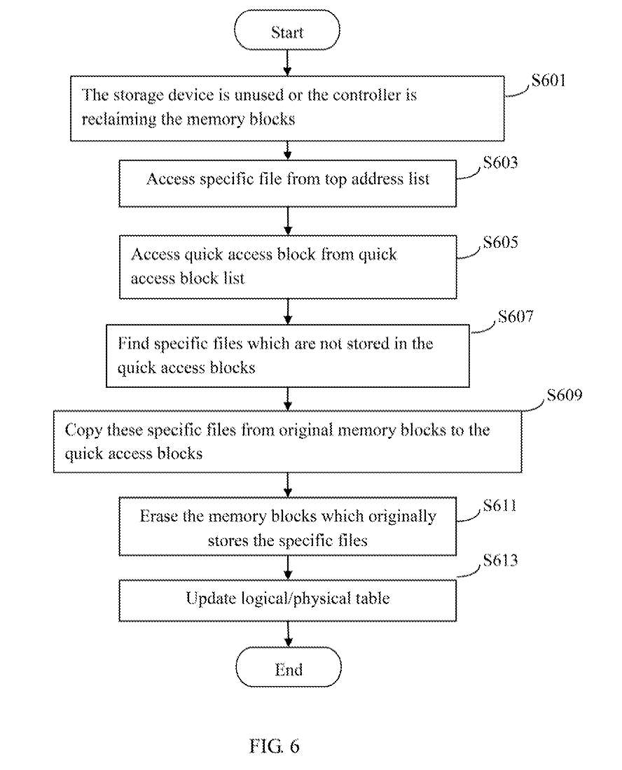

FIG. 6 is a flowchart of conveying a specific file of the present invention. As described above, the controller 240 records the top address list. When the storage device 220 is left unused or the controller 240 performs a procedure of reclaiming memory blocks (step S601), the conveying of the specific file is performed. The storage device 220 accesses the specific file firstly by the top address list (step S603) and then, accesses the quick access block through the quick access block list (step S605). The specific file, which is not stored in the quick access blocks, will be found according to the message recorded in the top address list and the quick access blocks (step S607). Then, these specific files will be copied from the original memory block to the quick access block (step S609), and the blocks originally storing these specific files will be erased (step S611). Finally, the logical/physical table will be updated (step S613). The logical address and the physical address of the specific file are correspondingly set. In such a manner, the access rate is accelerated because the specific file can be accessed directly from the quick access block next time.

As a whole, the present invention improves the access rate by writing the specific file to the quick access block with high reliabilities. First, the flash memory is initialized, the quick access block is selected, and the logical address is counted. Then, the data which is frequently accessed will be regarded as a specific file stored in the quick access block. During accessing the data, the storage device judge whether the data to be accessed is the specific file. If it is not the specific file, the common access procedure is performed. If it is the specific file, the quick access block will be correspondingly performed.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

What is claimed is:

1. A storage device for connecting to a host system, comprising:
a flash memory comprising a plurality of memory blocks; and
a controller coupled to the flash memory, said controller writing test data to the flash memory, comprising the test data read from the flash memory with the original test data to generate an bit error message corresponding to the flash memory, choosing and labeling a quick read block from said plurality of memory blocks according to said bit error message, and writing specific file to said quick read block.

2. The storage device as claimed in claim 1, wherein said specific file is set by the host system.

3. The storage device as claimed in claim 1, wherein said specific file is data which is frequently read.

4. The storage device as claimed in claim 1, wherein said bit error message is chosen from a group composed by the number of bit errors in each memory block, the average number of bit errors in each memory block, the number of memory pages without bit errors in each memory block, and their combinations.

5. The storage device as claimed in claim 4, wherein said quick read block is chosen from the memory blocks in which the number of the bit errors is lower than a preset number, the average number of the bit errors is lower than the preset number, or the number of the memory pages without bit error is higher than the preset number.

6. A data processing method, applied with a storage device which includes a plurality of memory blocks, said data processing method comprising following steps:
writing test data to each of said memory blocks;
reading the test data from said memory blocks and comparing the test data with the original test data and generating an bit error message corresponding to respective memory block;
choosing and labeling a quick read block from said plurality of memory blocks according to the bit error message; and
writing specific file to said quick read block.

7. The data processing method as claimed in claim 6, wherein said specific file is set according to the user's command.

8. The data processing method as claimed in claim 6, wherein said specific file is data which is frequently read.

9. The data processing method as claimed in claim 8, further comprising following steps:
collecting logical address which reads said data, and generating top address list corresponding to said specific file; and
updating said top address list when read said data of said logical address each time.

10. The data processing method as claimed in claim 9, further comprising following steps:
getting said specific file from said top address list and finding the specific file that is not stored in said quick read block; and
copying said specific file from the original memory block to said quick read block and erasing said original memory block which stores said specific file.

11. The data processing method as claimed in claim 6, wherein said bit error message is chosen from a group composed by the number of bit errors in each memory block, the average number of bit errors in each memory block, the number of memory pages without it errors in each memory block, and their combinations.

12. The data processing method as claimed in claim 11, wherein said quick read block is chosen from the memory blocks in which the number of the bit errors is lower than a preset number, the average number of the bit errors is lower than the preset number, or the number of the memory pages without bit error is higher than the preset number.
